(19) United States
(12) Patent Application Publication
(10) Pub. No.: US 2007/0148395 A1
(43) Pub. Date: Jun. 28, 2007

(54) Multilayer optical recording medium

(75) Inventors: Hiroshi Shingai, Tokyo (JP); Hideaki Miura, Tokyo (JP); Tatsuya Kato, Tokyo (JP); Hiroshi Takasaki, Tokyo (JP); Hironori Kakiuchi, Kobe-shi (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/638,360

(22) Filed: Dec. 14, 2006

(30) Foreign Application Priority Data
Dec. 28, 2005 (JP) 2005-380045

(51) Int. Cl. B32B 3/02

(52) U.S. Cl. 428/64.4

(57) ABSTRACT

A multilayer optical recording medium is provided with a totally reflective first information layer provided on a substrate and a second information layer being a translucent information layer provided via a spacer layer. The second information layer is composed of a TiO₂ layer, a first dielectric layer, a reflective film, a second dielectric layer, a recording film, and a third dielectric layer, all of which are laminated together in this order. The first dielectric layer is made of ZrO₂, Cr₂O₃, and Al₂O₃, and has a refractive index in the range of 1.84 to 2.20. If the recoding film is made of a material containing Sb as a main component, it is possible to strike a balance between high values of both the transmittance and the degree of modulation in recording information by laser light with a wavelength of 405 nm using an optical recording system having an optical system with a numerical aperture NA=0.85.

### BACKGROUND OF THE INVENTION

1. Field of the Invention

The present invention relates to a multilayer optical recording medium having two or more information layers.

2. Description of the Related Art

At the present time, Blu-ray Disc (registered trademark) systems have been proposed that contain a laser diode with a wavelength λ of 405 nm and an optical system with a numerical aperture NA=0.85. More specifically, one of these systems has been proposed that includes an optical recording medium with a capacity of 50 GB which has two information layers that are together on one side, those being a totally reflective information layer and a translucent information layer.

In a multilayer optical recording medium having two or more information layers, to record and reproduce information on and from the information layer farthest from a light incident surface, the information layers aside from the farthest information layer have to be translucent. In such a case, a recording film and a reflective film in the translucent information layer have to be made thin.

In the multilayer optical recording medium having two or more information layers, where the L0 layer refers to the information layer farthest from the light incident surface, the L1 layer therefore refers to the translucent information layer adjacent to the L0 layer on the light incident surface side, and the L2, etc . . . layers refer to likewise, the transmittance of the L1 layer has to be 40% or more.

To secure such high transmittance, as disclosed in, for example, Japanese Patent Laid-Open Publication No. 2003-16687, a method using a dielectric with a high refractive index in addition to making the thicknesses of the recording film and the reflective film thin is described.

Increasing the transmittance of the information layer, however, generally reduces the degree of modulation and degrades the quality of the recording signal. The degree of modulation, which is represented by {(the reflectivity of a not-recorded section)−(the reflectivity of a recorded section)}/(the reflectivity of the not-recorded section), has to be 40% or more in each information layer. This degree of modulation differs according to the type of material used for the recording film. In the case where the recording film is made of, for example, an Sb eutectic material having Sb as the main component, it is difficult to strike a balance between the transmittance and the degree of modulation for the information layer.

In an optical recording medium with the structure disclosed in Japanese Patent Laid-Open Publication No. 2003-16687, it is possible to increase the transmittance of the translucent information layer. When this structure is used in the translucent information layer with a recording film having Sb as the main component, however, there is a problem in that the degree of modulation is extensively reduced and the recording characteristics worsen.

Also, when laser light is applied, heat tends to accumulate in the translucent information layer because the thickness of the translucent information layer is thin. In, for example, an optical recording medium disclosed in Japanese Patent No. 3639218, each of the two or more information layers on the side of the light incident surface is composed of a transparent dielectric, a recording layer, another transparent dielectric, a translucent reflective layer, and a transparent heat-sink layer. The transparent heat-sink layer is made of AlN, Al₂O₃, SiC, or the like. However, there is a problem in that this optical recording medium is lacking in a balance between the various recording characteristics such as the transmittance, the degree of modulation, and the jitter of the translucent information layer.

Japanese Patent Laid-Open Publication No. 2004-30878 similarly discloses an optical recording medium with a rapid cooling structure in which an intermediate heat-sink layer such as ITO is provided between a spacer layer positioned between the information layers and a translucent reflective layer of a translucent information layer in order to improve the recording characteristic. In the optical recording medium disclosed in Japanese Patent Laid-Open Publication No. 2004-30878, however, there still remains a problem in that the transmittance and degree of modulation in the translucent information layer are insufficient.

Furthermore, an optical recording medium disclosed in Japanese Patent Laid-Open Publication No. Hei 9-91755 is provided with a dielectric layer made of ZnS:SiO₂ on a translucent reflective film. In this example also, the transmittance and degree of modulation are insufficient to provide a satisfactory translucent information layer.

### SUMMARY OF THE INVENTION

In view of the foregoing problems, various exemplary embodiments of this invention provide a multilayer optical recording medium having a translucent information layer including a recording film with Sb as the main component which can strike a balance between high values of both the transmittance and the degree of modulation in the translucent information layer.

As a result of diligent study, the inventor has found that providing a TiO₂ layer and a first dielectric layer made of ZrO₂, Cr₂O₃, and Al₂O₃ between a spacer layer positioned between information layers and a second dielectric layer in a translucent information layer or between the spacer layer and a reflective film made it possible to strike a balance between high values of both the transmittance and the degree of modulation.

In summary, the above-described objectives are achieved by the following embodiments of the present invention.

(1) A multilayer optical recording medium comprising: a substrate; a first information layer provided on the substrate; at least one translucent information layer provided on the first information layer; and a spacer layer provided between the information layers, recording laser light being incident on the multilayer optical recording medium from a side away from the substrate, wherein the at least one translucent information layer comprises a TiO₂ layer, a first dielectric layer, a second dielectric layer, a recording film having Sb as a main component, and a third dielectric layer, all of which are laminated in this order, and the first dielectric layer is made of ZrO₂, Cr₂O₃, and Al₂O₃ and has a refractive index in a range of 1.84 to 2.20.

(2) The multilayer optical recording medium according to (1), comprising a translucent reflective film positioned between the first dielectric layer and the second dielectric layer.

(3) The multilayer optical recording medium according to (1) or (2), wherein the first dielectric layer has an extinction coefficient in a range of 0.1 or less.

(4) The multilayer optical recording medium according to (1), (2), or (3), wherein in the first dielectric layer the composition of ZrO₂:Cr₂O₃:Al₂O₃ is in a range of ratios of (70:10:20), (10:50:40), (10:20:70), or (20:10:70) mol %.

(5) The multilayer optical recording medium according to any one of (1) to (4), wherein the thickness of the first dielectric layer is in a range of 5 nm to 25 nm or in a range of 100 nm to 120 nm.

(6) The multilayer optical recording medium according to any one of (1) to (4), wherein the thickness of the first dielectric layer is in a range of 5 nm to 25 nm.

This invention has the effect of keeping the transmittance value high by using TiO₂, which is a dielectric with a high refractive index, and also has the effect of preventing the reduction of the degree of modulation due to TiO₂ by positioning the first dielectric with a low refractive index between TiO₂ and the reflective film or between TiO₂ and the second dielectric layer.

### BRIEF DESCRIPTION OF THE DRAWINGS

FIG. 1 is a sectional view schematically showing a multilayer optical recording medium according to a first exemplary embodiment of the present invention;

FIG. 2 is a ternary drawing showing the relationship of the composition ratio among ZrO₂, Cr₂O₃, and Al₂O₃ composing a first electric layer according to the first exemplary embodiment;

FIG. 3 is a graph showing the relationship among a refractive index, transmittance, and a degree of modulation in a translucent information layer;

FIG. 4 is a graph showing the relationship between a composition ratio and an optical constant in the case where Cr₂O₃:Al₂O₃ of the first dielectric layer is made in accordance with the first exemplary embodiment;

FIG. 5 is a graph showing the relationship among the thickness, transmittance, and degree of modulation of the first dielectric layer according to the first exemplary embodiment; and

FIG. 6 is a sectional view schematically showing a multilayer optical recording medium according to a second exemplary embodiment of the present invention.

### DETAILED DESCRIPTION OF THE PREFERRED EMBODIMENTS

According to the best mode of this invention, a multilayer optical recording medium includes: a first information layer which is composed of a totally reflective information layer and a second information layer being a translucent information layer positioned adjacent to the first information layer via a spacer layer. The second information layer comprises TiO₂, a first dielectric layer, a translucent reflective film, a second dielectric layer, a recording film with Sb as the main component, and a third dielectric layer, all of which are laminated together in this order. The first dielectric layer is made of ZrO₂, Cr₂O₃, and Al₂O₃. The first dielectric layer also has a refractive index in the range of 1.84 to 2.20, and an extinction coefficient in the range of 0.1 or less, the composition of ZrO₂:Cr₂O₃:Al₂O₃ is in the range of ratios of (70:10:20), (10:50:40), (10:20:70), or (20:10:70) mol %, and is of a thickness in the range of 5 nm to 25 nm.

### First Exemplary Embodiment

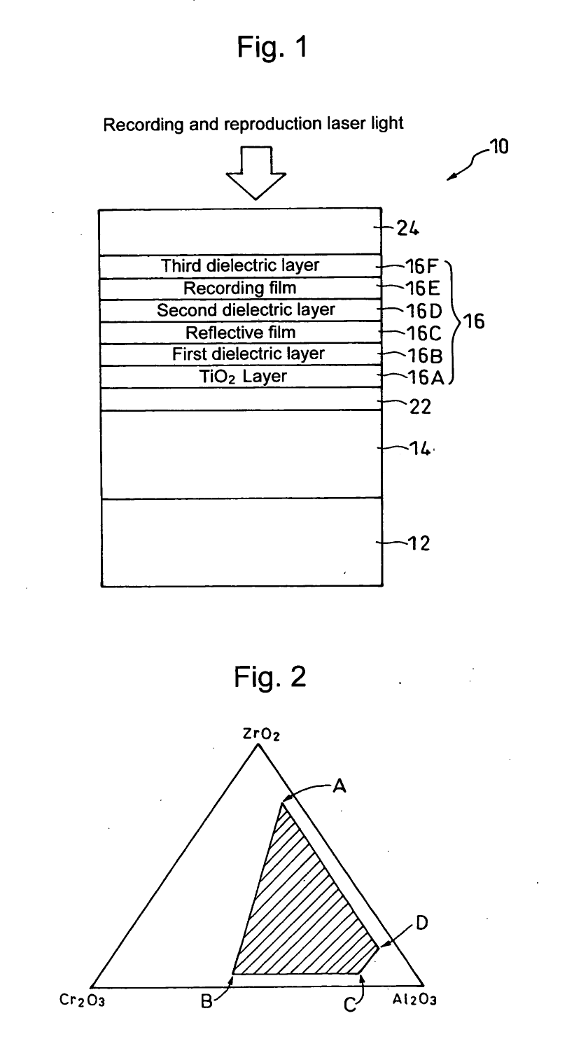

A multilayer optical recording medium 10 according to a first exemplary embodiment of the present invention will now be described with reference to FIG. 1.

This multilayer optical recording medium 10 includes a substrate 12, a totally reflective first information layer 14 provided on the substrate 12, a second information layer 16 being a translucent information layer provided on the first information layer 14, a spacer layer 22 provided between the first information layer 14 and the second information layer 16, and a cover layer 24 being a light transmission layer formed to cover the second information layer 16. The recording laser light is incident from the side away from the substrate 12.

The second information layer 16 includes a TiO₂ layer 16A, a first dielectric layer 16B, a reflective film 16C, a second dielectric layer 16D, a recording film 16E, and a third dielectric layer 16F, all of which are laminated together in this order from the substrate 12 side.

The first dielectric layer 16B is made of ZrO₂, Cr₂O₃, and Al₂O₃ and has a refractive index in the range of 1.84 to 2.20.

The substrate 12 is made of polycarbonate with a thickness of 1.1 mm. The totally reflective first information layer 14 is formed by sputtering, but an explanation thereof will be omitted because the first information layer 14 has the same structure as an information layer found in an ordinary single-layer optical recording medium.

The spacer layer 22 has a thickness of 25 μm, and is formed by transferring Gr. The thickness of the cover layer 24 is 75 μm.

The second information layer 16 is formed on the spacer layer 22. The TiO₂ layer 16A has a thickness in the range of 3 nm to 20 nm, but may have a thickness in the range of 4 nm to 10 nm.

The reflective film 16C is included for heat dissipation and light interference effects. It is preferable that the reflective film 16C is made of an Ag alloy. The thickness of the reflective film 16C is in the range of 0 nm to 20 nm due to its translucent structure. When the medium has two information layers, it is preferable that the reflective film 16C has a thickness in the range of 5 nm to 15 nm. When the medium has three or more information layers, it is preferable that the reflective film 16C has a thickness which is in the range of more than 0 nm to 12 nm.

The second dielectric layer 16D controls heat dissipation from the recording film. The type of material used as the second dielectric layer 16D is not especially limited, and an oxide, nitride, sulfide, carbide, or fluoride of at least one kind of metal selected from the group consisting of Ti, Zr, Hf, Ta, Si, Al, Mg, Y, Ce, Zn, In, Cr, Nb, and mixtures thereof is available. The thickness thereof is in the range of 2 nm to 20 nm. The recording film is not sufficiently protected when the thickness of the second dielectric layer is less than 2 nm, and the heat dissipation of the recording film is reduced when the thickness thereof is more than 20 nm.

The recording film 16E contains Sb in the range of 60 to 90 at %. The amount of the contained Sb may set in the range of 75 to 88 at %. The recording film 16E may contain Te, Ge, In, Sn, Zn, Si, Mg, or the like in addition to Sb. The thickness of the recording film 16E is in the range of 2 nm to 9 nm, but may set in the range of 3 nm to 8 nm.

The type of material used as the third dielectric layer 16F is not especially limited, and the third dielectric layer 16F may be made of a plurality of dielectrics. The third dielectric layer 16F may be composed of an interface layer, a ZnS+SiO₂ layer, and a heat-sink layer, all of which are laminated together on the recording film 16E.

It is preferable that the interface layer is made of a material which has Cr₂O₃ as the main component. In this case, the main component makes up a molar ratio of 50% or more of the entire interface layer. It is preferable that the thickness of the interface layer is in the range of 0.2 nm to 8 nm. The preferable molar ratio of the ZnS+SiO₂ layer between ZnS and SiO₂ is in the range of 50:50 to 95:5. If the molar ratio moves out of this range, the refractive index of the mixture of ZnS and SiO₂ varies, so that any adjustment of the optical characteristic the ZnS+SiO₂ layer becomes difficult. It is preferable that the thickness of the third dielectric layer 16F is in the range of 5 nm to 50 nm. It becomes difficult to protect the recording layer and adjust any optical characteristic when the thickness is less than 5 nm, and heat dissipation from the recording film to the heat-sink layer is reduced when the thickness of the third dielectric layer 16F is more than 50 nm.

The heat-sink layer controls heat dissipation from the recording film and increases the cooling effect of the recording film, making an amorphous mark easy to form precisely. The type of material used as the dissipation layer is not especially limited, but a material with thermal conductivity higher than the ZnS+SiO₂ layer such as AlN, SiN, BN, Al₂O₃, and TiO₂ is preferable. In preferred exemplary embodiments, the heat-sink layer is made of AlN. The preferable thickness of the heat-sink layer is in the range of 15 nm to 150 nm, and more preferably in the range of 20 nm to 120 nm. When the thickness of the heat-sink layer is less than 15 nm, the heat dissipation effect of the recording layer is reduced. When the thickness is more than 150 nm, more time is required to deposit the film and as such, productivity is reduced.

In the first exemplary embodiment, the first dielectric layer 16B was made of ZrO₂:Cr₂O₃:Al₂O₃ (65:10:25 mol %) or ZrO₂:Cr₂O₃ (90:10 mol %). Samples 1 to 8 were provided in which the thickness of the TiO₂ layer and the first dielectric layer were varied, and the degree of modulation and the transmittance were measured. The results are shown in Tables 1 and 2. The thickness and material used in the other layers were as follows: the reflective film 16C; 10 nm and AgPdCu respectively, the second dielectric layer 16D; 4 nm and ZrO₂:Cr₂O₃ (90:10 mol %) respectively, the recording film 16E; 6 nm and SbGe (87:13 at %) respectively, and the third dielectric layer 16F consisting of; the interface layer, 5 nm and Cr₂O₃/ZnS+SiO₂, 20 nm and (80:20 mol %) respectively/the heat-sink layer, 45 nm and AlN respectively.

TABLE 1

| Sample | TiO₂ | ZrO₂:Cr₂O₃:Al₂O₃ | Degree of | Transmittance |
|---|---|---|---|---|
| No. | (nm) | (nm) | modulation (%) | (%) |
| 1 | 5 | 10 | 42.1 | 43.0 |
| 2 | 5 | 5 | 44.5 | 41.1 |
| 3 | 10 | 5 | 41.0 | 43.8 |
| 4 | 5 | 15 | 40.3 | 47.8 |

TABLE 2

| | TiO₂ | | Degree of | Transmittance |
|---|---|---|---|---|
| Sample No. | (nm) | ZrO₂:Cr₂O₃ (nm) | modulation (%) | (%) |
| 5 | 5 | 10 | 36.9 | 42.4 |
| 6 | 20 | 10 | 28.3 | 42.7 |
| 7 | 10 | 20 | 34.9 | 41.9 |
| 8 | 5 | 5 | 41.0 | 39.0 |

It is apparent from table 1 that samples 1 to 4 satisfy 40% or more in terms of both of the degree of modulation and the transmittance. It is apparent from table 2, on the other hand, that samples 5 to 8 do not satisfy 40% in terms of the degree of modulation and the transmittance.

The refractive index n and the extinction coefficient k of a single-layer film in each of the cases of ZrO₂:Cr₂O₃:Al₂O₃ and ZrO₂:Cr₂O₃ were measured using a wavelength λ=405 nm of the recording laser light. The results are shown in table 3.

TABLE 3

| | n | k |
|---|---|---|
| ZrO₂:Cr₂O₃:Al₂O₃ | 2.12 | 0.01 |
| ZrO₂:Cr₂O₃ | 2.29 | 0.01 |

It is apparent from table 3 that when the refractive index of the first dielectric layer exceeds 2.2, the transmittance is increased but the degree of modulation is reduced. Accordingly, it is preferable that the refractive index is 2.2 or less.

In optical recording mediums identical to those detailed above, the transmittance was measured while varying the composition ratio of the first dielectric layer (ZrO₂:Cr₂O₃:Al₂O₃) with a thickness of 10 nm. Table 4 shows results.

TABLE 4

| Sample No. | ZrO₂(mol %) | Cr₂O₃(mol %) | Al₂O₃(mol %) | n | k | Transmittance |
|---|---|---|---|---|---|---|
| 9 | 65 | 10 | 25 | 2.12 | 0.01 | 43.0 |
| 10 | 40 | 10 | 50 | 1.97 | 0.01 | 41.2 |
| 11 | 20 | 10 | 70 | 1.84 | 0.01 | 40.2 |
| 12 | 10 | 10 | 80 | 1.77 | 0.01 | 39.6 |

It is apparent from table 4 that when the refractive index of the first dielectric layer is less than 1.84, the transmittance is less than 40%. Thus, it is preferable that the refractive index of the first dielectric layer is 1.84 or greater.

The refractive indexes of each single layer of ZrO₂, Cr₂O₃, and Al₂O₃, being materials composing the first dielectric layer, are 2.26, 2.65, and 1.60, respectively. It is possible to calculate the refractive index of a mixed oxide of these materials from the composition ratio of each oxide. The following table 5 shows these composition ratios and calculated refractive indexes.

TABLE 5

| Sample | ZrO₂ | Cr₂O₃ | Al₂O₃ | |
|---|---|---|---|---|
| No. | (mol %) | (mol %) | (mol %) | n |
| 13 | 80 | 10 | 10 | 2.23 |
| 14 | 70 | 10 | 20 | 2.17 |
| 15 | 65 | 10 | 25 | 2.12 |
| 16 | 60 | 10 | 30 | 2.10 |
| 17 | 50 | 10 | 40 | 2.04 |
| 18 | 40 | 10 | 50 | 1.97 |
| 19 | 30 | 10 | 60 | 1.90 |
| 20 | 10 | 10 | 80 | 1.77 |
| 21 | 20 | 10 | 70 | 1.84 |
| 22 | 70 | 20 | 10 | 2.27 |
| 23 | 60 | 20 | 20 | 2.21 |
| 24 | 50 | 20 | 30 | 2.14 |
| 25 | 40 | 20 | 40 | 2.07 |
| 26 | 30 | 20 | 50 | 2.01 |
| 27 | 20 | 20 | 60 | 1.94 |
| 28 | 10 | 20 | 70 | 1.88 |
| 29 | 50 | 30 | 20 | 2.25 |
| 30 | 40 | 30 | 30 | 2.18 |
| 31 | 30 | 30 | 40 | 2.11 |
| 32 | 20 | 30 | 50 | 2.05 |
| 33 | 10 | 30 | 60 | 1.98 |
| 34 | 40 | 40 | 20 | 2.28 |
| 35 | 30 | 40 | 30 | 2.22 |
| 36 | 20 | 40 | 40 | 2.15 |
| 37 | 10 | 40 | 50 | 2.09 |
| 38 | 30 | 50 | 20 | 2.32 |
| 39 | 20 | 50 | 30 | 2.26 |
| 40 | 10 | 50 | 40 | 2.19 |

According to table 5, the composition range (mol %) of ZrO₂:Cr₂O₃:Al₂O₃ which exhibits a refractive index in the range of 1.84 to 2.19 is represented by a diagonally shaded area connecting A(70:10:20), B(10:50:40), C(10:20:70), and D(20:10:70), as shown in FIG. 2.

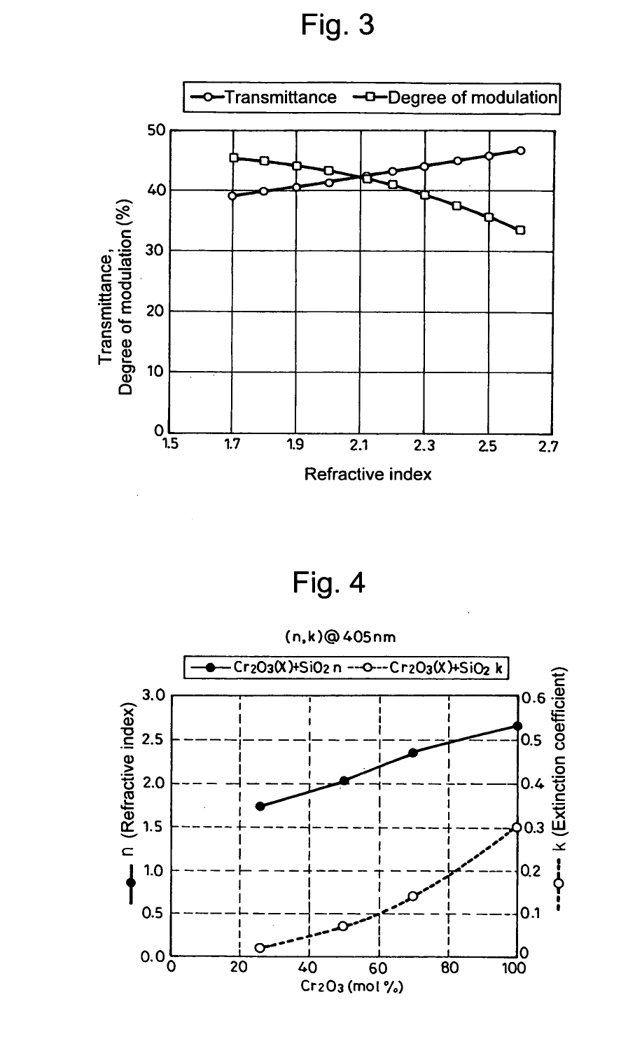

Table 6 and FIG. 3 show the mutual relationship between the refractive index, the transmittance, and the degree of modulation.

TABLE 6

| Sample | Cr₂O₃ | Al₂O₃ | | |
|---|---|---|---|---|
| No. | (mol %) | (mol %) | n | k |
| 41 | 100 | 0 | 2.65 | 0.3 |
| 42 | 70 | 30 | 2.35 | 0.14 |
| 43 | 50 | 50 | 2.02 | 0.07 |
| 44 | 26 | 74 | 1.73 | 0.02 |

It is apparent from table 6 and FIG. 3 that when the refractive index is 2.12, the optimal balance between the transmittance and the degree of modulation is achieved.

In the first dielectric layer 16B, a Cr₂O₃:Al₂O₃ dielectric was manufactured by using Cr₂O₃ with the highest refractive index and Al₂O₃ with the lowest refractive index. The composition ratio was then varied and the optical constants were measured. The results are shown in table 7 and FIG. 4.

TABLE 7

| Refractive index | Transmittance | Degree of modulation |
|---|---|---|
| 2.6 | 46.7 | 33.7 |
| 2.5 | 45.8 | 35.8 |
| 2.4 | 44.9 | 37.7 |
| 2.3 | 44 | 39.4 |
| 2.2 | 43.1 | 41.1 |
| 2.12 | 42.4 | 42.1 |
| 2 | 41.4 | 43.3 |
| 1.9 | 40.6 | 44.1 |
| 1.8 | 39.9 | 44.8 |
| 1.7 | 39.1 | 45.3 |

It is apparent from table 7 and FIG. 4 that the composition of Cr₂O₃ has to be equal to, or less than, 60 mol % and the extinction coefficient has to be equal to, or less than, 0.1 to make the refractive index of the first dielectric layer 16B equal to, or less than, 2.2.

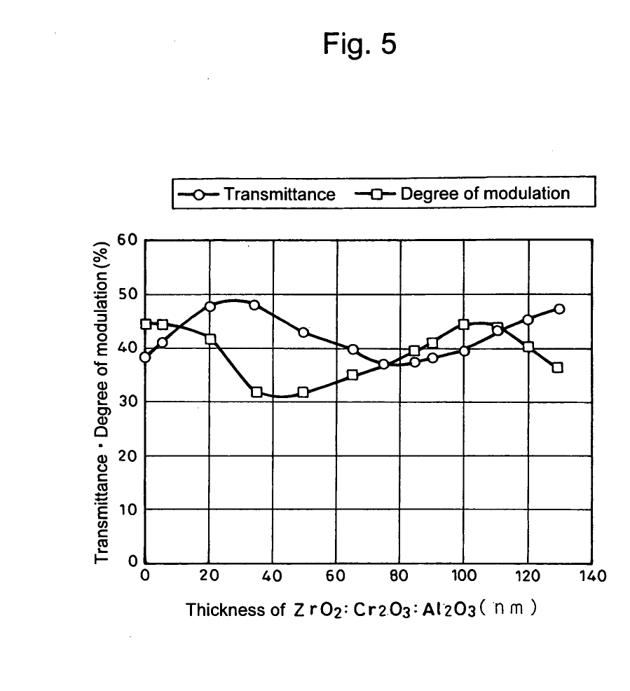

Table 9 and FIG. 5 show the relationship between the degree of modulation and the transmittance with respect to the thickness of the first dielectric layer, measured by varying the thickness X of the film structure shown in the following table 8.

TABLE 8

| Structure | Material | Thickness (nm) |
|---|---|---|
| 16F | AlN | 45 |
| | ZnS + SiO₂ | 20 |
| 16E | SbGe | 6 |
| 16D | ZrO₂ + Cr₂O₃ | 4 |
| 16C | AgPdCu | 10 |
| 16B | ZrO₂ + Cr₂O₃ + Al₂O₃ | X |
| 16A | TiO₂ | 5 |

TABLE 9

| | Degree of modulation | Transmittance |
|---|---|---|
| X (nm) | (%) | (%) |
| 0 | 45.0 | 38.6 |
| 5 | 44.5 | 41.1 |
| 20 | 42.1 | 48.1 |
| 35 | 31.9 | 48.2 |
| 50 | 31.7 | 43.2 |
| 65 | 34.8 | 39.5 |
| 75 | 37.0 | 37.1 |
| 85 | 39.0 | 36.9 |
| 90 | 40.8 | 37.8 |
| 100 | 44.2 | 39.4 |
| 110 | 44.2 | 43.1 |
| 120 | 40.1 | 45.3 |
| 130 | 36.3 | 47.0 |

It is apparent from table 9 and FIG. 5 that when the thickness of the first dielectric layer (ZrO₂:Cr₂O₃:Al₂O₃, composition ratio of 65:10:25 mol %) is in the range of 5 nm to 25 nm or in the range of 100 nm to 120 nm, the degree of modulation and the transmittance are high and offer a good balance. In particular, this is true when the thickness of the first dielectric layer is in the range of 5 nm to 25 nm or less.

### Second Exemplary Embodiment

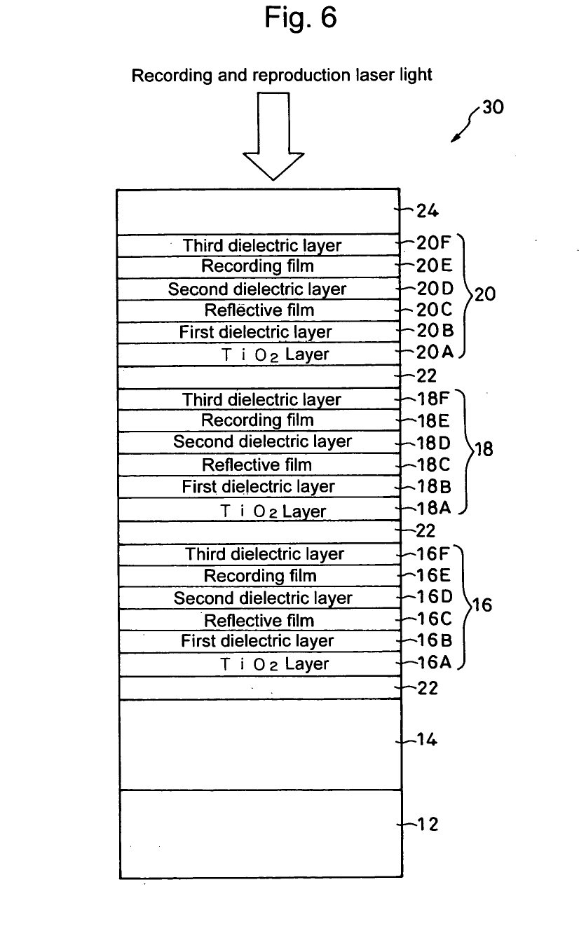

A second exemplary embodiment of the present invention will now be described with reference to FIG. 6.

A multilayer optical recording medium 30 according to the second exemplary embodiment is a four-layer optical recording medium. A third information layer 18 and a fourth information layer 20, each of which serves as a translucent information layer, are provided in addition to the structure of the multilayer optical recording medium according to the foregoing first exemplary embodiment. Spacer layers 22 are provided between the second information layer 16 and the third information layer 18 and between the third information layer 18 and the fourth information layer 20, and a cover layer 24 is provided so as to cover the fourth information layer 20.

As in the case of the second information layer 16, the third information layer 18 is composed of a TiO₂ layer 18A, a first dielectric layer 18B, a reflective film 18C, a second dielectric layer 18D, a recording film 18E, and a third dielectric film 18F, all of which are laminated together in this order.

The fourth information layer 20 is also composed of a TiO₂ layer 20A, a first dielectric layer 20B, a reflective film 20C, a second dielectric layer 20D, a recording film 20E, and a third dielectric film 20F, all of which are laminated together in this order.

Since the third and fourth information layers 18 and 20 have the same structure as the second information layer 16, a detailed description of their structure will be omitted.

In the multilayer optical recording medium 30 according to the second exemplary embodiment, however, the light transmittance of the fourth information layer 20, the third information layer 18, and the second information layer 16 become smaller in this order.

It should be appreciated that the present invention is not limited to the two-layer optical recording medium and the four-layer optical recording medium according to the foregoing first and second exemplary embodiments, but may also be applied to a three-layer optical recording medium.

What is claimed is:

1. A multilayer optical recording medium comprising: a substrate; a first information layer provided on the substrate; at least one translucent information layer provided on the first information layer; and a spacer layer provided between the information layers, recording laser light being incident on the multilayer optical recording medium from a side away from the substrate, wherein
the at least one translucent information layer comprises a TiO₂ layer, a first dielectric layer, a second dielectric layer, a recording film having Sb as a main component, and a third dielectric layer, all of which are laminated in this order, and the first dielectric layer is made of ZrO₂, Cr₂O₃, and Al₂O₃ and has a refractive index in a range of 1.84 to 2.20.

2. The multilayer optical recording medium according to claim 1, comprising a translucent reflective film positioned between the first dielectric layer and the second dielectric layer.

3. The multilayer optical recording medium according to claim 1, wherein the first dielectric layer has an extinction coefficient in a range of 0.1 or less.

4. The multilayer optical recording medium according to claim 2, wherein the first dielectric layer has an extinction coefficient in a range of 0.1 or less.

5. The multilayer optical recording medium according to claim 1, wherein in the first dielectric layer the composition of ZrO₂:Cr₂O₃:Al₂O₃ is in a range of ratios of (70:10:20), (10:50:40), (10:20:70), or (20:10:70) mol %.

6. The multilayer optical recording medium according to claim 2, wherein in the first dielectric layer the composition of ZrO₂:Cr₂O₃:Al₂O₃ is in a range of ratios of (70:10:20), (10:50:40), (10:20:70), or (20:10:70) mol %.

7. The multilayer optical recording medium according to claim 3, wherein in the first dielectric layer the composition of ZrO₂:Cr₂O₃:Al₂O₃ is in a range of ratios of (70:10:20), (10:50:40), (10:20:70), or (20:10:70) mol %.

8. The multilayer optical recording medium according to claim 1, wherein the thickness of the first dielectric layer is in a range of 5 nm to 25 nm or in a range of 100 nm to 120 nm.

9. The multilayer optical recording medium according to claim 2, wherein the thickness of the first dielectric layer is in a range of 5 nm to 25 nm or in a range of 100 nm to 120 nm.

10. The multilayer optical recording medium according to claim 3, wherein the thickness of the first dielectric layer is in a range of 5 nm to 25 nm or in a range of 100 nm to 120 nm.

11. The multilayer optical recording medium according to claim 5, wherein the thickness of the first dielectric layer is in a range of 5 nm to 25 nm or in a range of 100 nm to 120 nm.

12. The multilayer optical recording medium according to claim 1, wherein the thickness of the first dielectric layer is in a range of 5 nm to 25 nm.

13. The multilayer optical recording medium according to claim 2, wherein the thickness of the first dielectric layer is in a range of 5 nm to 25 nm.

14. The multilayer optical recording medium according to claim 3, wherein the thickness of the first dielectric layer is in a range of 5 nm to 25 nm.

15. The multilayer optical recording medium according to claim 5, wherein the thickness of the first dielectric layer is in a range of 5 nm to 25 nm.
